(19) United States
(12) Patent Application Publication
(10) Pub. No.: US 2013/0091764 A1
(43) Pub. Date: Apr. 18, 2013

(54) BONDING AGENTS FOR FUEL PRODUCTS, METHODS OF THEIR PREPARATION AND PRODUCTS PRODUCED THEREWITH

(71) Applicant: Momentive Specialty Chemicals Inc., Columbus, OH (US)

(72) Inventors: Steven J. Wantling, Hoover, AL (US); Kenneth Cargill, Pollok, TX (US); Harden Christopher Wren, Lufkin, TX (US); Eileene Keating, Kennesaw, GA (US)

(73) Assignee: Momentive Specialty Chemicals Inc., Columbus, OH (US)

(21) Appl. No.: 13/654,148

(22) Filed: Oct. 17, 2012

Related U.S. Application Data
(60) Provisional application No. 61/548,300, filed on Oct. 18, 2011.
(60) Provisional application No. 61/597,577, filed on Feb. 10, 2012.

(51) Int. Cl. C09J 103/02; C08L 29/04; C08L 29/06; C08K 5/1545; C08K 5/151; C08K 5/053; C10L 5/44; C08L 33/06

(52) U.S. Cl. 44/577; 524/52; 524/53; 106/215.5

(57) ABSTRACT

Disclosed are bonding agents useful in the production of pelletized or briquetted fuels. The bonding agents may be incorporated into a feed containing the fuel material, providing both adhesion and cohesion of the fines to produce a uniform and predictable pellet or briquette. Specifically, the bonding composition contains a solubulized starch, a sugar source and/or a diol or polyol compound, and optionally a polymer selected from polyvinyl alcohol (PVOH), PVOH copolymers, polyvinyl acetate (PVA), polyvinyl acetate copolymers (PVAc), ethylene vinyl acetate (EVAc or VAE) or any subset or combination of such polymers. Also disclosed are methods of preparing the bonding agents and to densified and/or torrefied biomass products prepared therewith.

### FIELD OF THE INVENTION

The present invention relates to bonding agents useful in the production of pelletized or briquetted fuels, for example densified and/or torrefied biomass products. Specifically, the present invention relates to bonding agent compositions containing a solubulized starch, a sugar source, such as beet molasses, and/or a diol or polyol compound such as glycerine, and optionally a polymer selected from polyvinyl alcohol (PVOH), PVOH copolymers, polyvinyl acetate (PVA), polyvinyl acetate copolymers (PVAc), ethylene vinyl acetate (EVAc or VAE) or any subset or combination of such polymers. In addition, the present invention relates to methods of preparing the bonding agents and to the pelletized or briquetted fuel products prepared therewith.

### BACKGROUND OF THE INVENTION

Torrefaction of biomass, such as wood, cellulose, hemicellulose, lignin, other cellulosic materials such as grasses, or peat moss, as well as coke and coal fines, and then the densification of the torrefied biomass, in the form of, for example pellets or briquettes, provides a compact material containing little moisture which exhibits enhanced fuel quality during combustion.

During the densification process, the biomass material, which may or may not be torrefied, may be pulverized then introduced into a conventional pelletizing mill to produce a cohesive pellet. During the pulverization process, fines are developed having a typical moisture content of between about 10 and about 25 weight percent (wt %). In some process, the fines may comprise more than 90% of the feed to be pelletized. However, these fines are not easily converted into uniform pellets.

Accordingly, there is a need for a bonding agent that may be incorporated into a feed containing biomass to be pelletized or briquetted, which bonding agent will provide both adhesion and cohesion of the fines to produce a uniform and predictable fuel product. There is also a need, in the case of torrefied and densified wood pellets, for such a bonding agent that will also provide structural integrity to the pellets, while further enhancing in their hydrophobicity.

### SUMMARY OF THE INVENTION

In one embodiment, there is provided a bonding agent useful in the production of fuel products which includes a solubulized starch, a sugar source, and/or a diol or polyol compound. In another embodiment, the bonding agent of the invention optionally includes a polymer PVOH, PVOH copolymers, PVA, PVAc, EVAc, or any subset or combinations thereof. In another embodiment, the fuel product is a densified and/or torrefied biomass product.

In another embodiment, there is provided a method of preparing a bonding agent useful in the production of fuel products which includes combining a solubulized starch, a sugar source, and/or a diol or polyol compound. In another embodiment an aqueous solution of PVOH is back added to the bonding agent of invention.

In another embodiment there is provided a densified and/or torrefied biomass product, prepared with a bonding agent which contains a solubulized starch, a sugar source, and/or a diol or polyol compound, and optionally PVOH, PVOH copolymers, PVA, PVAc, EVAc, or any subset or combination thereof.

In another embodiment there is provided a method of preparing a densified and/or torrefied biomass product which includes combining densified and/or torrefied biomass with a bonding agent which contains a solubulized starch, a sugar source, and/or a diol or polyol compound, and optionally PVOH, PVOH copolymers, PVA, PVAc, EVAc, or any subset or combination thereof.

### DETAILED DESCRIPTION OF THE INVENTION

The present invention provides bonding agents useful in the production of densified and/or torrified biomass products, such as, for example, wood pellets. The bonding agents include a solubulized starch, a sugar source, such as beet molasses, and/or a diol or polyol, such as a glycerine, and optionally a polymer selected from PVOH, PVOH copolymers, PVA, PVAc, EVAc, or any subset or combination of such polymers.

The solubulized starch may be any generic starch species, for example from corn, sago, wheat, rice, etc. In one embodiment, the starch is modified. In another embodiment, the solublized starch is an acid modified starch prepared, as is known in the art, by treating the starch with an acid, such as hydrochloric acid, to break down the starch molecule thereby reducing viscosity.

In another embodiment the solublized starch is an oxidized starch prepared, as is known in the art, by treating the starch with an oxidizing agent, such as sodium hypochlorite, which also reduces viscosity.

In another embodiment, the starch is an unmodified starch. In another embodiment the unmodified starch is pearl starch, which refers to the physical form of the starch, typically resulting from being kiln dried.

In one embodiment, the sugar source is beet molasses which is the syrup left after the final crystallization stage in the production of beet sugar. Beet molasses typically contains about 50 wt % sugar, mostly in the form of sucrose, but also with significant amounts of glucose and fructose.

In one embodiment, the diol (two hydroxyl functional groups) or polyol (more than two hydroxyl functional groups) is selected from one or more of glycerine, ethylene glycol, propylene glycol, diethylene glycol, dipropylene glycol and combinations thereof.

In another embodiment, the bonding agents of the invention optionally include PVOH or a PVOH copolymer. The PVOH or copolymer may have a viscosity from about 1 centipoise (cps) to about 11 cps, such as from about 2.5 cps to about 4.5 cps, and may have a molecular weight from about 13,000 to about 23,000. The PVOH or copolymer may by hydrolyzed from at greater than 85%, such as greater than 95%, for example hydrolyzed from about 98% to 99%. The PVOH or copolymer may be in the form of a solid or an aqueous solution, for example, an aqueous solution of 20% PVOH, such as that available commercially under the tradename CELVOL™, from Seikisui Inc, of Japan, in a broad range of molecular weights, all of which are useful in the compositions of the invention. Examples of suitable PVOH materials are neodecanoic acid ethenyl ester polymers with ethanol, acetic ethenyl ester polymers with ethenol, and combinations thereof. One example is CELVOL™ 203 solution which is a partially hydrolyzed vinyl acetate copolymer at a concentration of 92-95% and a percent hydrolysis between 87-89%.

In another embodiment, the bonding agents of the invention optionally include a polymer selected from PVA, PVAc or EVAc. Suitable examples of which include neodecanoic acid ethenyl ester polymers with ethenyl acetate, acetic ethenyl ester polymers with ethenyl acetate, and combinations thereof. One example of a polyvinyl acetate aqueous solution is Adesivo PEK 4000 (PVAc) solution, which is commercially available from Momentive Specialty Chemicals Inc., of Columbus, Ohio.

In one embodiment, the bonding agents of the invention contain between about 70 to about 95 weight percent (wt %) water, from about 3 to about 15 wt % starch, from about 5 to about 15 wt % sugar source, diol and/or polyol. In another embodiment, the bonding agent of the invention contains between about 70 to about 95 wt% water, from about 3 to about 15 wt % acid modified starch, from about 5 to about 15 wt % beet sugar molasses. The wt % being based upon the total weight of the bonding agent.

The PVOH or compolymer, when utilized, may be present in an amount from about 0.05 to about 10 wt %, such as about 0.3 to about 2.5 wt %, for example, at about 0.6 wt % based on the total weight of the bonding agent.

The PVA, PVAc or EVAc, when utilized, may be present in the emulsion in and amount of from about 0.1 to about 5.0 wt %, such as about 0.5 to about 5.0 st %, for example, at about 2.50 wt % based on the total weight of the bonding agent.

The process of the invention includes solubilizing the starch, and heating to reach gelation completion, incorporating into the developed starch mixture either a sugar source, such as beet molasses and/or a diol or polyol, such as glycerin. The PVOH, PVOH copolymers, PVA, PVAc, EVAc, or any subset or combination thereof, when utilized, is back added into the composition.

In one embodiment, the bonding agent of the invention comprises about 10 to about 20 wt % solids, based upon the weight of the bonding agent.

In one embodiment, the bonding agent of the invention is provided in the form of a concentrate containing greater than 20 wt % solids.

In one embodiment, when PVOH, PVOH copolymers, PVA, PVAc, EVAc, or any subset or combination thereof, is included in the bonding agent, the pellets remain physically unchanged after a minimum of 250 hours of immersion in water. In another embodiment, when PVOH is added, the pellets remain physically unchanged after a minimum of 300 hours of immersion in water. In another embodiment, when PVOH is included, the pellets remain physically unchanged after a minimum of 500 hours of immersion in water. In another embodiment the pellets remain physically unchanged up to 500 hours of immersion in water.

While not wishing to be limited by theory, the inventors believe the starch component provides for adhesive bond development between the individual fine wood structures to produce structural integrity of the feed matrix. The beet molasses component provides and reconstitutes the normal wood sugars, oxidized in the torrefaction process. Additionally, the bonding agent of the invention provides a linkage of the wood fine material for some measure of cohesion, thereby providing a polar film aggressively adhering to the metallic pelletizing die, to provide a measure of lubricity resulting in increased production through the mill and decreased die wear.

In order to provide a better understanding of the present invention including representative advantages thereof, the following examples are offered.

### EXAMPLES

### Example 1

TABLE 1
Bonding Agent Formulation

| Component | grams | Wt % |
|---|---|---|
| Water | 400 | 56 |
| Acid Modified Starch | 40 | 6 |
| Beet Molasses | 80 | 10 |
| Water Back Add | 200 | 28 |

The water was aggressively agitated with the application of heat while the acid modified starch was added slowly. The mixture was held between 185 and 190° F. until the slurry clarified. After clarification, the mixture was removed from the heat source and agitated until ambient temperature was reached. After which, the beet molasses was added with continued agitation for about 30 minutes. The completed slurry was allowed to rest for 2 hours, then the back add water was incorporated, and the resultant slurry was agitated for 30 minutes.

MC-2 Mildewcide, commercially available from Supreme Chemical, Inc., Cumming Ga., was then added to the finished bonding agent set forth in Table 1, at a rate of 10 grams/gallon.

### Example 2

80% of the base starch/molasses composition of Table 1, was mixed with 20% of a 20% solids solution of CELVOL 203. The addition of CELVOL 203 resulted in a pellet integrity of >250 hours in total submersion in water, versus <1 hour for an untreated pellet.

While the present invention has been described and illustrated by reference to particular embodiments and examples, those of ordinary skill in the art will appreciate that the invention lends itself to variations not necessarily illustrated herein. For this reason, then, reference should be made solely to the appended claims for purposes of determining the true scope of the present invention.

We claim:

1. A bonding agent for producing a fuel product, the bonding agent comprising:
a) about 3 wt % to about 15 wt % of a solubulized starch; and
b) about 5 wt % to about 15 wt % of a sugar source, a diol or a polyol;
wherein the wt % is based upon the total weight of the bonding agent.

2. The bonding agent of claim 1 wherein the starch is an acid modified starch.

3. The bonding agent of claim 1 wherein component b) comprises beet molasses.

4. The bonding agent of claim 1 wherein component b) comprises glycerine, ethylene glycol, propylene glycol, diethylene glycol, dipropylene glycol, or combinations thereof.

5. The bonding agent of claim 1 further comprising:
c) about 0.05 wt % to about 10 wt % polyvinyl alcohol or a poly vinyl alcohol copolymer;
wherein the wt % is based upon the total weight of the bonding agent.

6. The bonding agent of claim 1 further comprising:
c) about 0.1 to about 5.0 wt % of polyvinyl acetate or a polyvinyl acetate copolymer, wherein the wt % is based upon the total weight of the bonding agent.

7. The bonding agent of claim 1 wherein component c) comprises a partially hydrolyzed vinyl acetate copolymer.

8. The bonding agent of claim 5 wherein the fuel product is a wood pellet and wherein the wood pellet remains physically unchanged after 250 hours of immersion in water.

9. A method of preparing a bonding agent for a fuel product comprising the steps of:
a) heating a solubilized starch to reach gelation completion to form a developed starch, and
b) incorporating a sugar source, a diol or a polyol into the developed starch, wherein bonding agent comprises about 3 wt % to about 15 wt % of a solubulized starch, and about 5 wt % to about 15 wt % of the sugar source, a diol or a polyol, and wherein the wt % is based upon the total weight of the bonding agent.

10. The method of claim 9 wherein the solubilized starch is an acid modified starch.

11. The method of claim 9 wherein the sugar source comprises beet molasses.

12. The method of claim 9 wherein the diol or polyol comprises glycerine, ethylene glycol, propylene glycol, diethylene glycol, dipropylene glycol, or combinations thereof.

13. The method of claim 9 further comprising the step of back adding about 0.05 wt % to about 10 wt % polyvinyl alcohol or a poly vinyl alcohol copolymer, wherein the wt % is based upon the total weight of the bonding agent.

14. The method of claim 9 further comprising the step of back adding about 0.1 to about 5.0 wt % of polyvinyl acetate or a polyvinyl acetate copolymer, wherein the wt % is based upon the total weight of the bonding agent.

15. A fuel product comprising the bonding agent of claim 1.

16. The fuel product of claim 15, wherein the fuel product is comprise wood, cellulose, hemicellulose, lignin, grasses, peat moss, coke, coal fines or combinations thereof.

17. The fuel product of claim 15, wherein the fuel product is densified.

18. The fuel product of claim 15, wherein the fuel product is torrefied.

19. The fuel product of claim 15, wherein the fuel product is in the form of pellets or briquettes.

20. The fuel product of claim 15, wherein the bonding agent comprises a polymer, and the fuel product is a pellet that remains physically unchanged after a minimum of 250 hours of immersion in water.
